(19) United States
(12) Patent Application Publication
(10) Pub. No.: US 2007/0189638 A1
(43) Pub. Date: Aug. 16, 2007

(54) Image processing apparatus, image forming apparatus and image processing method

(75) Inventors: Mieko Ohkawa, Tokyo (JP); Jun Nakagawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/635,522

(22) Filed: Dec. 8, 2006

(30) Foreign Application Priority Data
Feb. 10, 2006 (JP) 2006-033651

(51) Int. Cl. G06K 9/32

(52) U.S. Cl. 382/299

(57) ABSTRACT

Disclosed herein is an image processing apparatus, including: a pattern-matching unit for judging whether a pixel array of a predetermined image region including a target pixel in a binary image data coincides with each pixel array of a plurality of previously prepared template data or not; and a resolution converter for preparing high-resolution image data having a higher resolution than the image data by using a pixel block composed of the predetermined number of pixels, based on a judgment result by the pattern-matching unit, wherein an output gradient value of the target pixel and position information of output pixels are set to each of the plurality of template data, and when the pattern-matching unit judges that there is template data coinciding with the pixel array of the image region, the resolution converter outputs a pixel block in which the same gradient value as the output gradient value is reproduced, based on the output gradient value and the position information of the output pixels which are set to the template data coinciding with the pixel array.

### BACKGROUND OF THE INVENTION

1. Field of the Invention

The present invention relates to an image processing apparatus for converting image data having a low resolution to image data having a high resolution, an image forming apparatus comprising the image processing apparatus, and an image processing method.

2. Description of Related Art

Conventionally, having been suggested is a technique in which a smoothing processing is carried out for an edge part of a character image or a line image or the like by the template matching method. For example, Japanese Patent Unexamined Publication No. 2000-83168 (hereinafter referred to as Patent Publication 1) discloses a technique in which image data having a high resolution is obtained by carrying out a density conversion processing and a pulse width modulation processing for a target pixel to be smoothed. Also disclosed in Japanese Patent Unexamined Publication No. 2001-157041 (hereinafter referred to as Patent Publication 2) is a technique in which an edge judgment for detecting an edge part of multilevel image data and a pattern matching judgment for judging whether a predetermined region of multilevel image data coincides with a predetermined pattern or not are carried out to perform a smoothing processing for the edge part and to provide the multilevel image data having a higher resolution. In the technique disclosed in Patent Publication 2, the edge judgment and the pattern matching judgment are further carried out for the image data having a high resolution.

However, in the technique disclosed in Patent Publication 1, there is a problem in which because the smoothing processing is performed in one direction, it is unable to obtain an image having a high quality. Furthermore, in the technique disclosed in Patent Publication 2, there is a problem in which, a complicated process is necessary because the positions of surrounding pixels to be referred to as a gradient value of an output value of an output pixel are decided at the time when the multilevel image data is caused to have a high resolution. In addition, there is a problem in which because the edge judgment and the pattern matching judgment are further carried out for image data having a high resolution, a memory capacity required for the processing is increased.

### SUMMARY

An object of the present invention is to be capable of preparing image data having a superior high resolution by a simple processing.

To achieve at least one of the above-described objects, an image processing apparatus reflecting one aspect of the invention, comprises:

a pattern-matching unit for judging whether a pixel array of a predetermined image region including a target pixel in a binary image data coincides with each of pixel arrays of a plurality of previously prepared template data or not; and

a resolution converter for preparing high-resolution image data having a higher resolution than the image data by using a pixel block composed of the predetermined number of pixels, based on a judgment result by the pattern-matching unit,

wherein output gradient value of the target pixel and position information of output pixels are set to each of the plurality of template data, and

when the pattern-matching unit judges that there is template data coinciding with the pixel array of the image region, the resolution converter outputs a pixel block in which the same gradient value as the output gradient value is reproduced, based on the output gradient value and the position information of the output pixels which are set to the template data coinciding with the pixel array.

An image forming apparatus reflecting one aspect of the invention, comprises:

the above-described image processing apparatus; and

an image forming unit for forming an image on a recording medium based on image data subjected to an image processing by the image processing apparatus.

An image processing method reflecting one aspect of the invention, comprises:

judging whether a pixel array of a predetermined image region including a target pixel in a binary image data coincides with each of pixel arrays of a plurality of previously prepared template data or not; and

preparing high-resolution image data having a higher resolution than the image data by using a pixel block composed of the predetermined number of pixels, based on a judgment result in the judging,

wherein an output gradient value of the target pixel and position information of output pixels are set to each of the plurality of template data, and

when it is judged that there is template data coinciding with the pixel array of the image region in the judging, a pixel block in which the same gradient value as the output gradient value is reproduced, is outputted in the preparing based on the output gradient value and the position information of the output pixels which are set to the template data coinciding with the pixel array.

### BRIEF DESCRIPTION OF THE DRAWINGS

The present invention will become fully understood by the detailed description and the accompanying drawings by a given by way of illustration only, and thus are not intended as a definition of the limits of the present invention, and wherein:

FIG. 1 is a block diagram illustrating the structure of main components of an image forming apparatus according to an embodiment of the present invention;

FIG. 2 is a view illustrating a relation between image data having a low resolution and image data having a high resolution;

FIG. 3 is a view illustrating output gradient values of pixel blocks;

FIG. 4 is a view illustrating an example of template data stored in ROM;

FIG. 5 is a view illustrating an example of template data stored in ROM;

FIG. 6 is a view illustrating an example of template data stored in ROM;

FIG. 7 is a view illustrating examples of position information of an output pixel set in the template data and a four-pixel block outputted based on the output gradient value;

FIG. 8A to FIG. 8D are views illustrating examples of a resolution conversion; and

FIG. 9 is a flowchart illustrating an image processing executed in the image processing apparatus.

### DETAILED DESCRIPTION OF THE PREFERRED EMBODIMENT

Hereinafter, an embodiment of an image processing apparatus, an image forming apparatus, and an image processing method of the present invention will be described with reference to the drawings.

First, the structure in this embodiment will be described.

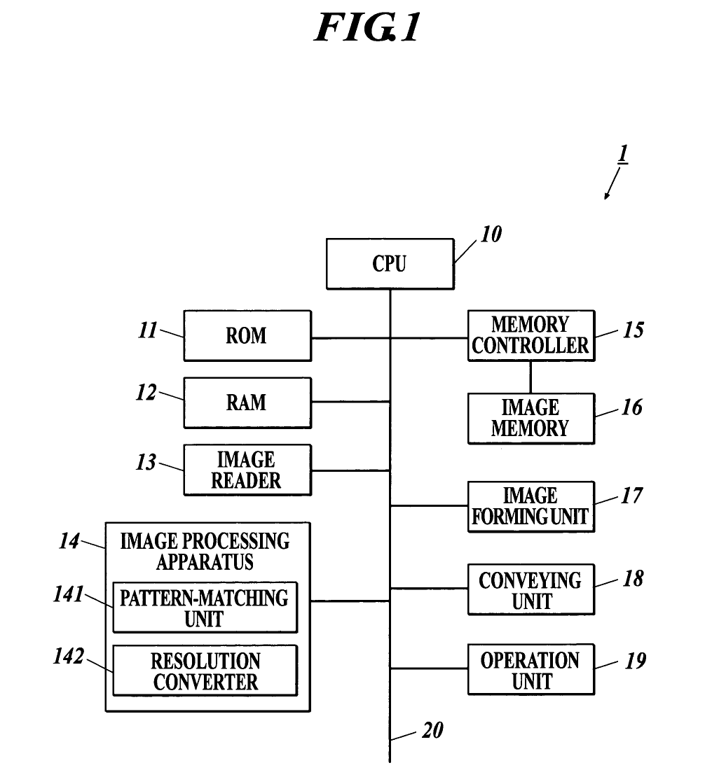

FIG. 1 illustrates the structure of an image forming apparatus 1 according to this embodiment. As shown in FIG. 1, the image forming apparatus 1 comprises a central processing unit (CPU) 10, a read only memory (ROM) 11, a random access memory (RAM) 12, an image reader 13, an image processing apparatus 14, a memory controller 15, an image memory 16, an image forming unit 17, a conveying unit 18 and an operation unit 19. The respective units of the image forming apparatus 1 are connected to one another via a bus 20.

The CPU 10 controls the operations of the respective units of the image forming apparatus 1 in accordance with a control program stored in the ROM 11.

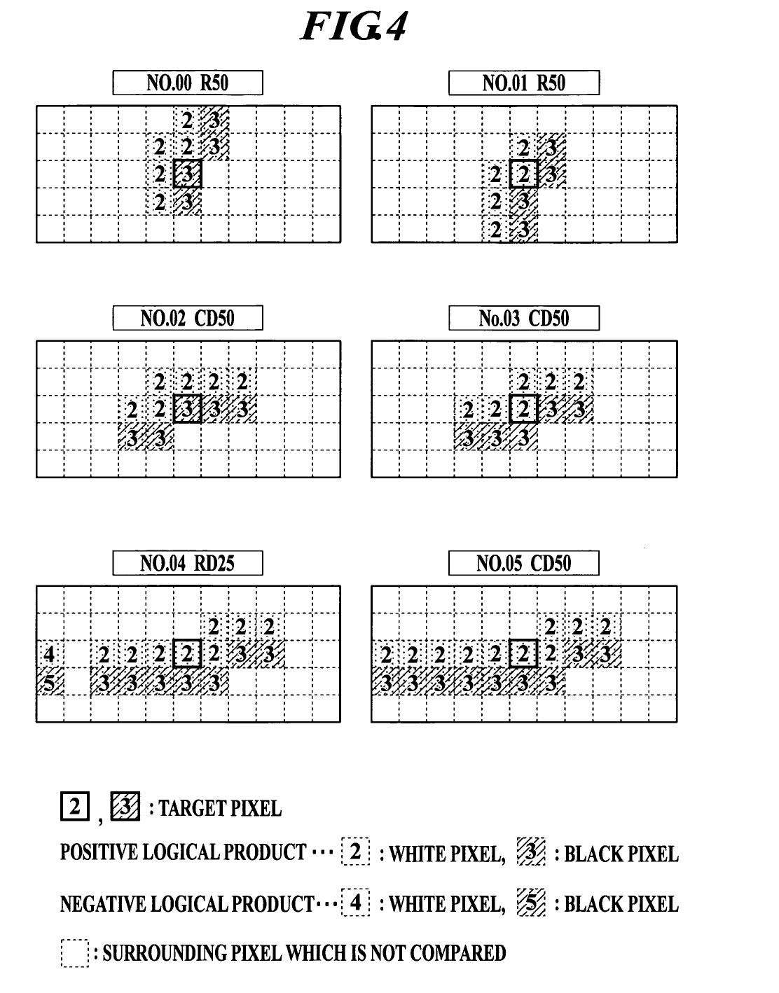

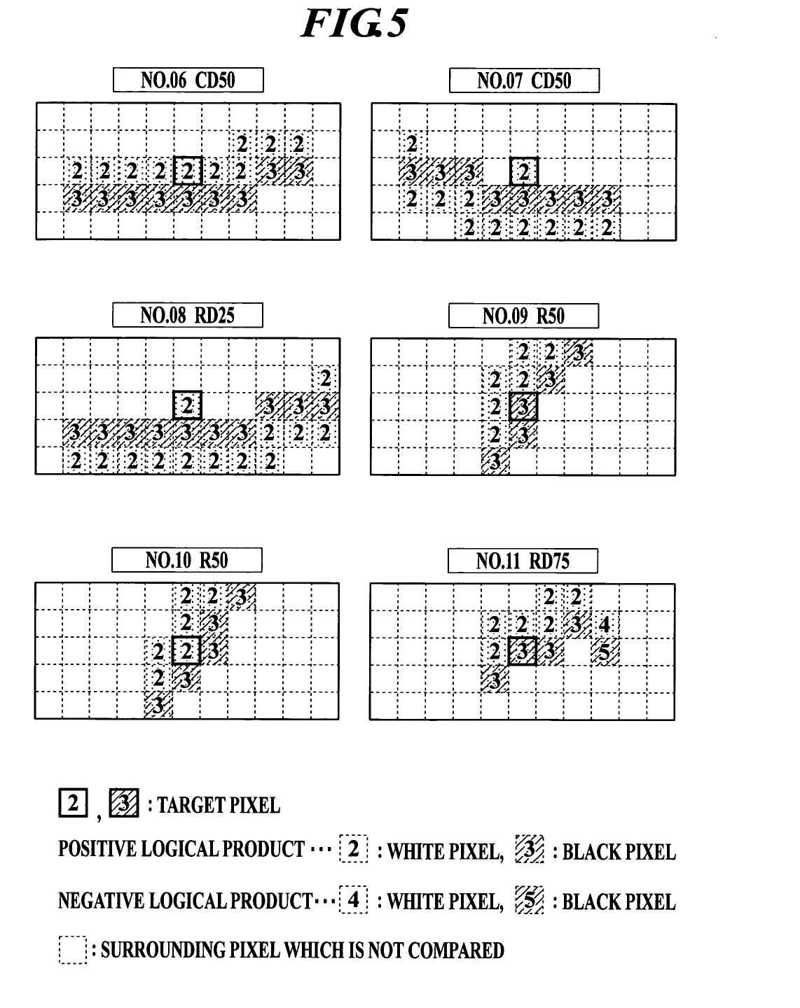

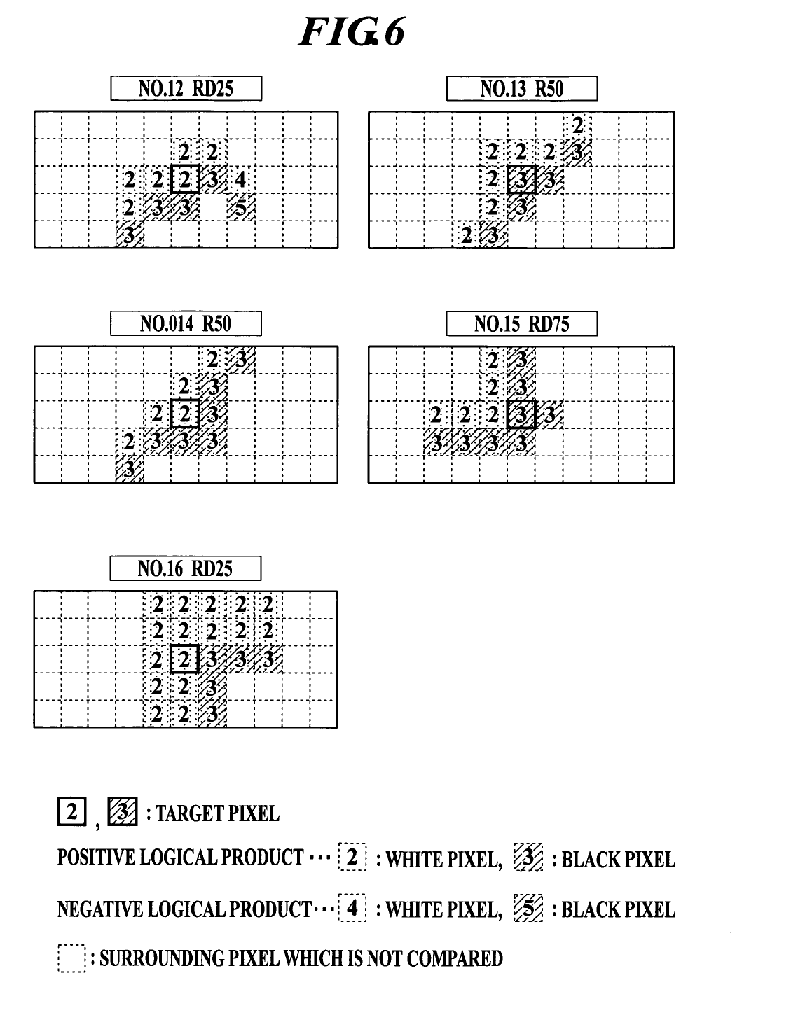

The ROM 11 stores a control program executed by the CPU 10, for realizing various functions related to the operation of the image forming apparatus 1 and data used for the execution of the control program. For example, the ROM 11 stores data for a template used for a template matching processing executed in the image processing apparatus 14 (see FIGS. 4 to 6).

The RAM 12 expands various control programs executed by the CPU 10 to a program storage area and temporarily stores inputted data, data for a processing result caused when various control programs are executed, or the like, in a work area.

The image reader 13 comprises a scanner and the like and reads image information of a document by a scanner to generate the image data. Specifically, the image reader 13 scans a document placed on a transparent contact glass by lighting from a light source. The image forming of the reflecting light is carried out by a charge coupled device (CCD). An image data is generated by the photoelectric conversion to output the data to the image processing apparatus 14.

The image processing apparatus 14 carries out various image processings, such as variable power processing, filter processing, gamma conversion processing and the like for the inputted image data to cause the processed image data to be stored in the image memory 16. The image processing apparatus 14 comprises a pattern-matching unit 141 which carries out a pattern matching processing for the image data to be processed, which is read out from the image memory 16, with the template data stored in the ROM 11; and a resolution converter 142 which converts one pixel of image data to a pixel block composed of the predetermined number of pixels based on the processing result obtained by the pattern-matching unit 141 to output image data having a high resolution.

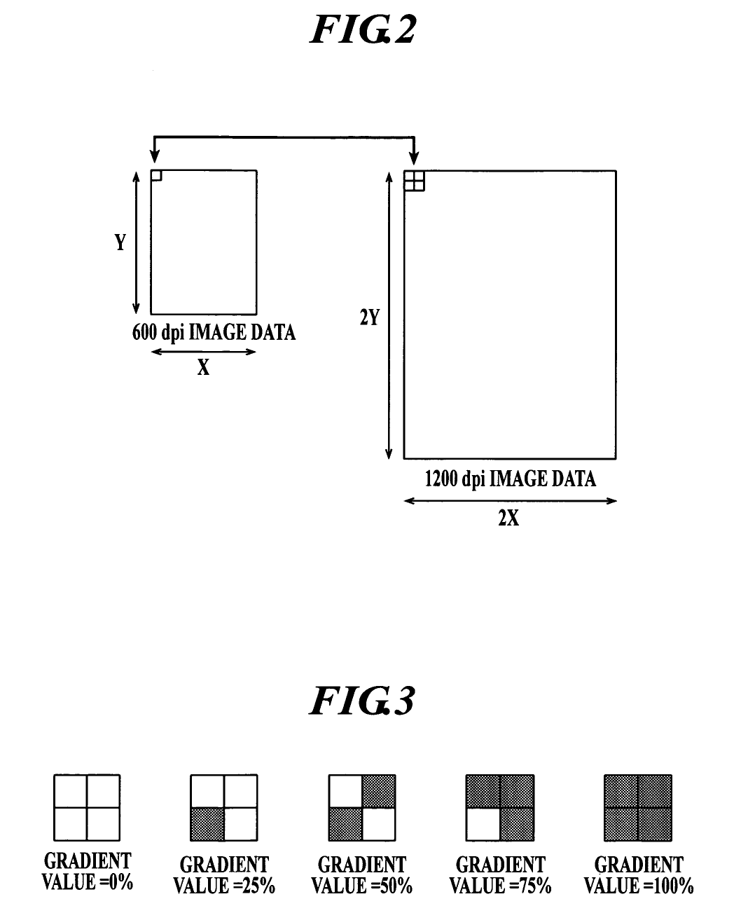

Before the processings of the respective components in the image processing apparatus 14 is described in detail, the resolution conversion method is explained. Image data having a high resolution is prepared by converting one pixel of the inputted original image data to a pixel block composed of n×m pixels (“n” and “m” are integers, wherein n≧1 and m≧1). The pixel block is determined based on the inputted original image data and the size of the image data having a high resolution, which will be prepared. For example, when 1200 dpi image data is prepared by using 600 dpi image data, one pixel of 600 dpi image data can be converted to a four-pixel block in which 2 pixels are arranged in height and 2 pixels are arranged in width, as shown in FIG. 2. Thereby, 1200 dpi image data can be prepared.

The number of the output gradient values which can be reproduced by a pixel block is determined based on the number of the gradient values of the image data having a high resolution, which will be prepared and the number n×m of pixels constituting a pixel block (hereinafter referred to as a pixel block value). For example, when 1200 dpi binary image data is prepared by using 600 dpi multilevel image data, a pixel block having target pixels is a four-pixel block in which 2 pixels are arranged in height and 2 pixels are arranged in width. This four-pixel block has five output gradient values (0%, 25%, 50%, 75%, and 100%) as shown in FIG. 3. Thus, the number of the output gradient values is calculated as shown in the formula (1).

The number of the output gradient values={(the number of the gradient values of the high-resolution image data−1)×pixel block value}+1 (1)

In FIG. 3, the number of the gradient values of the image data having a high resolution is 2 and the pixel block value is 4. By the formula (1), the number of the output gradient values is 5.

Next, the processings to be carried out by the pattern-matching unit 141 and the resolution converter 142 will be described in detail.

The pattern-matching unit 141 judges whether the pixel array of the predetermined image region including the target pixel of binary image data read out from the image memory 16 coincides with the respective pixel arrays of a plurality of template data stored in the ROM 11 or not. In the respective template data, the output gradient value of the target pixel and position information of an output pixel is set.

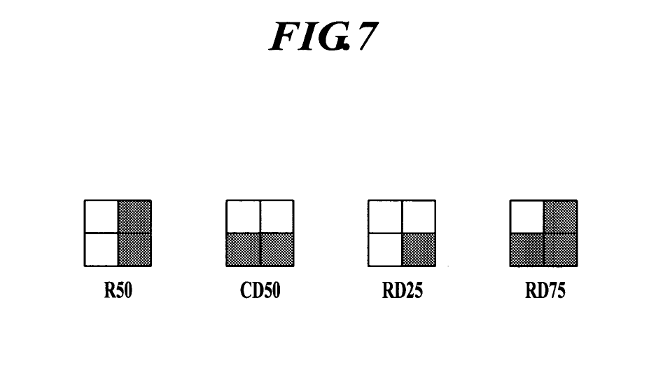

FIG. 4 to FIG. 6 illustrate examples of template data (No. 00 to No. 16) stored in the ROM 11. In FIG. 4 to FIG. 6, alphabets and numeric values shown at the sides of the template No. 00 to No. 16 respectively represent the position information of an output pixel (R: right adjustment, L: left adjustment, C: centering, U: up adjustment, D: down adjustment) and an output gradient value (%). FIG. 7 illustrates output examples corresponding to the output gradient values and the position information of the output pixels set to the template data. In the case of R50 for example, R50 means that the output gradient value is 50% and black pixels are outputted in the right adjustment (R).

As shown in FIG. 4 to FIG. 6, the position information of the output pixels set to the respective template data is information that is set based on positions of a black pixel and a white pixel surrounding the target pixel and that determines output positions of the respective pixels constituting a pixel block.

The output gradient value (%) set to each of the template data is set so that an error value of the output gradient value, which is caused to the target pixel before and after a gradient conversion, can be absorbed by an output gradient value of another template data which is different from the output gradient value of the template data used by the resolution converter 142. For example, an error value caused in a gradient conversion can be absorbed as much as possible by preparing template data as shown by the template No. 01 in which a white pixel is assumed as a target pixel and an output gradient value is 50%, with respect to template data as shown by the template No. 00 in which a black pixel is assumed as a target pixel and an output gradient value is 50%.

In the pattern matching carried out by the pattern-matching unit 141, based on the output gradient value and the position information of the output pixel set to template data coinciding with the pixel array of the inputted predetermined image region, the resolution converter 142 outputs a pixel block in which the same gradient value as the output gradient value is reproduced. When there is no template data which coincides with the pixel array during the pattern matching carried out by the pattern-matching unit 141, the resolution converter 142 outputs a pixel block in which the same gradient value as that of the target pixel included in the image region, is reproduced.

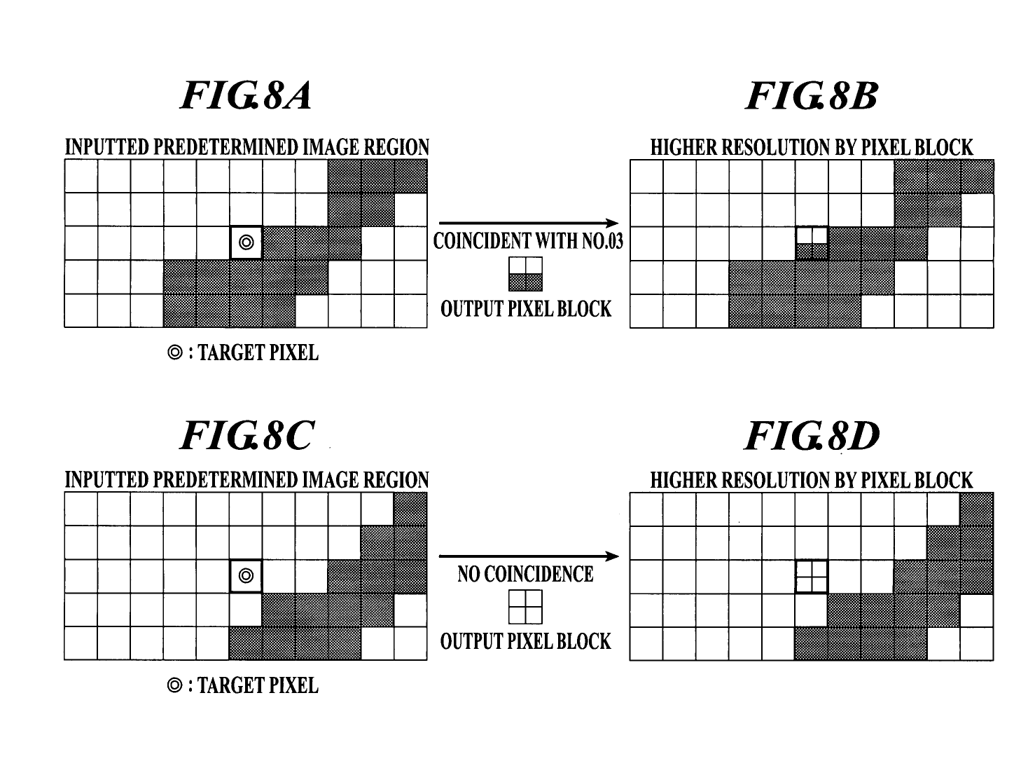

FIG. 8A to FIG. 8D illustrate examples of a resolution conversion in the resolution converter 142. For example, when the predetermined image region as shown in FIG. 8A is inputted to the pattern-matching unit 141, the pixel array of the image region coincides with the template data of the template No. 03. Thus, based on CD50 (output gradient value of 50%, center (C), down (D)) which is the output gradient value and the position information of the output pixel set to the coinciding template data, the resolution converter 142 outputs a pixel block corresponding to the target pixel, as shown in FIG. 8B. When the predetermined image region as shown in FIG. 8C is inputted to the pattern-matching unit 141, there is no template data coinciding with the pixel array of the image region. Thus, the resolution converter 142 outputs a pixel block in which the same gradient value (0%) as that of the target pixel is reproduced, as shown in FIG. 8D.

By operating the operation unit 19, it is possible to select an output gradient value in which each pixel of the pixel block outputted when the pattern-matching unit 141 judges that there is template data coinciding with the pixel array of the image region, can be reproduced.

Alternatively, whether a character image or a line image is made to have a high resolution by using template data or not also can be selected by the operation of the operation unit 19. The processing carried out by the resolution converter 142 can be executed regardless of the number of the gradient values (binary, multilevel) of high resolution image data to be prepared and the number of the gradient values can be selected by the operation of the operation unit 19.

Then, the explanation of the embodiment will be described with reference to FIG. 1. The memory controller 15 controls the access to the image memory 16 when image data is read out from the image memory or written in the image memory. The image memory 16 comprises a nonvolatile recording medium and stores image data processed by the image processing apparatus 14 therein.

The image forming unit 17 forms an image on a transfer paper (material to be recorded) in a predetermined print method (e.g., electrophotography method, ink jet method) based on a print control signal from the CPU 10. The conveying unit 18 uses a plurality of rollers to convey a transfer paper before and after the image forming.

The operation unit 19 is structured to include a touch panel integrally provided with a display screen, such as various function keys (e.g., numeric key, start key), Liquid Crystal Display (LCD) or the like. The operation unit 19 outputs an operation signal corresponding to a key operation and an operation signal corresponding to an input operation through the touch panel, to the CPU 10.

Next, the operation in this embodiment will be described.

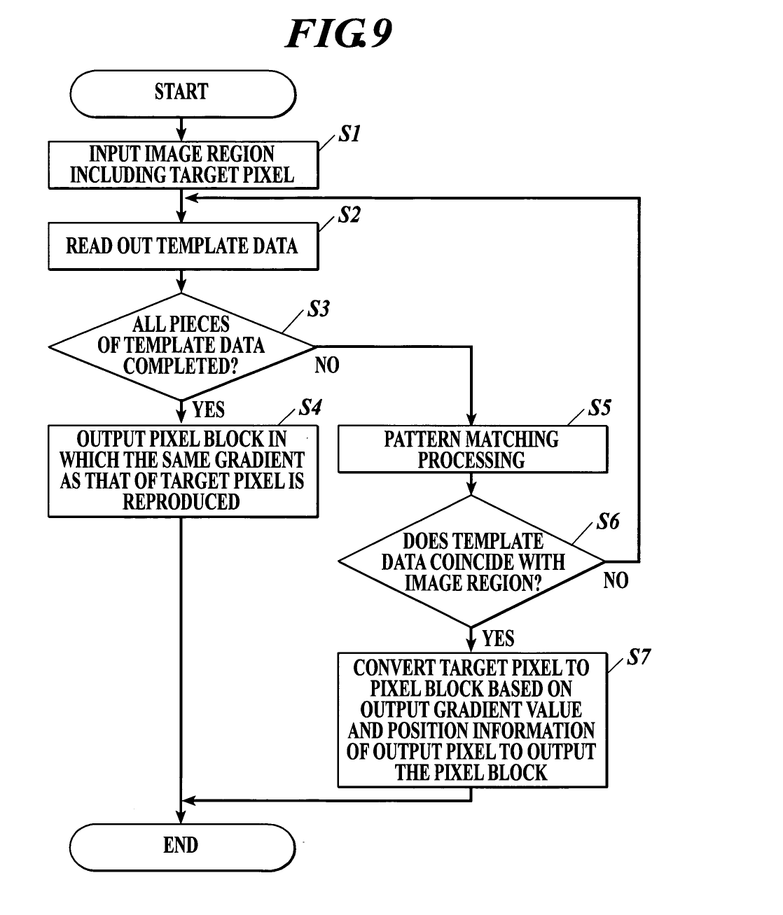

With reference to the flowchart of FIG. 9, an image processing executed by the image processing apparatus 14 will be described.

First, a predetermined image region including a target pixel is inputted to the pattern-matching unit 141 (Step S1). Then, template data is readout from the ROM 11 (Step S2). Next, it is judged whether all of template data are already subjected to a pattern matching processing or not (Step S3).

In Step S3, when it is judged that not all of the template data are subjected to the pattern matching processing (Step S3; NO), the pattern matching processing between the pixel array of the template data read out in Step S2 and the pixel array of the image region inputted in Step S1 is performed (Step S5). It is judged whether the template data coincides with the image region or not (Step S6).

In Step S6, when it is judged that the template data read out in Step S2 does not coincides with the image region inputted in Step S1 (Step S6; NO), next template data is read out from the ROM 11 (Step S2). Then, the processing of Step S3 is repeated.

In Step S6, when it is judged that the template data read out in Step S2 coincides with the image region inputted in Step S1 (Step S6; YES), based on the output gradient value and the position information of the output pixel set to the template data, a target pixel which is converted to a pixel block is outputted (Step S7). Then, the image processing is finished.

In Step S3, when it is judged that all of the template data are already subjected to the pattern matching processing (Step S3; YES), that is, when there is no template data coinciding with the pixel array of the image region including the target pixel, a pixel block in which the same output gradient value as that of the target pixel is reproduced is outputted (Step S4). Then, the image processing is finished.

As described above, according to the image forming apparatus 1 of this embodiment, it is possible to prepare image data having a high resolution, in which a high quality character image or line image can be reproduced, from original image data by a simple processing.

Even when there is no template data coinciding with the predetermined image region including the target pixel, a pixel block in which the same output gradient value as that of the target pixel is reproduced, is outputted. Therefore, it is possible to prepare image data having a high resolution without damaging the image quality.

Furthermore, in accordance with the position information of the output pixels set to the respective template data, it is possible to reproduce a character image or a line image by image data having a high resolution.

The output gradient values set to the respective template data are set so that an error value caused in the gradient conversion of the target pixel can be absorbed by an output gradient value of another template. Thus, even though the resolution of the image data is made to be higher, a gradient of the original image data can be reproduced.

Furthermore, because a user can select output gradient values in which the respective pixels of the pixel block can be reproduced, the freedom degree of a smoothing processing of image data having a high resolution is increased.

The present U.S. patent application claims the priority of Japanese Patent Application No. 2006-033651 filed on Feb. 10, 2006, according to the Paris Convention, and the above Japanese Patent Application is the basis for correcting mistranslation of the present U.S. patent application.

What is claimed is:

1. An image processing apparatus, comprising:
a pattern-matching unit for judging whether a pixel array of a predetermined image region including a target pixel in a binary image data coincides with each pixel array of a plurality of previously prepared template data or not; and
a resolution converter for preparing high-resolution image data having a higher resolution than the image data by using a pixel block composed of the predetermined number of pixels, based on a judgment result by the pattern-matching unit,
wherein an output gradient value of the target pixel and position information of output pixels are set to each of the plurality of template data, and
when the pattern-matching unit judges that there is template data coinciding with the pixel array of the image region, the resolution converter outputs a pixel block in which the same gradient value as the output gradient value is reproduced, based on the output gradient value and the position information of the output pixels which are set to the template data coinciding with the pixel array.

2. The image processing apparatus of claim 1, wherein:
when the pattern-matching unit judges that there is no template data coinciding with the pixel array of the image region, the resolution converter outputs a pixel block in which the same gradient value as that of the target pixel included in the image region is reproduced.

3. The image processing apparatus of claim 1, wherein the position information of the output pixel, which is set to each of the plurality of template data is information that is set based on positions of black pixels and white pixels surrounding the target pixel and that determines output positions of respective pixels constituting the pixel block.

4. The image processing apparatus of claim 1, wherein the output gradient value set to each of the plurality of template data is set so that an error value of the output gradient value, which is caused to the target pixel before and after a gradient conversion can be absorbed by an output gradient value of another template data which is different from the output gradient value of the template data used by the resolution converter.

5. The image processing apparatus of claim 1, wherein the output gradient value in which each pixel of the pixel block outputted when the pattern-matching unit judges that there is template data coinciding with the pixel array of the image region, can be reproduced, can be selected by operating an operation unit.

6. An image forming apparatus, comprising:
the image processing apparatus of claim 1; and
an image forming unit for forming an image on a material recording medium based on image data subjected to an image processing by the image processing apparatus.

7. An image processing method, comprising:
judging whether a pixel array of a predetermined image region including a target pixel in a binary image data coincides with each pixel array of a plurality of previously prepared template data or not; and
preparing high-resolution image data having a higher resolution than the image data by using a pixel block composed of the predetermined number of pixels, based on a judgment result in the judging,
wherein an output gradient value of the target pixel and position information of an output pixels are set to each of the plurality of template data, and
when it is judged that there is template data coinciding with the pixel array of the image region in the judging, a pixel block in which the same gradient value as the output gradient value is reproduced, is outputted in the preparing based on the output gradient value and the position information of the output pixel which are set to the template data coinciding with the pixel array.

8. The image processing method of claim 7, wherein
when it is judged that there is no template data coinciding with the pixel array of the image region in the judging, a pixel block in which the same gradient value as that of the target pixel included in the image region is reproduced, is outputted in the preparing.

9. The image processing method of claim 7, wherein the position information of the output pixel, which is set to each of the plurality of template data is information that is set based on positions of black pixels and white pixels surrounding the target pixel and that determines output positions of respective pixels constituting the pixel block.

10. The image processing method of claim 7, wherein the output gradient value set to each of the plurality of template data is set so that an error value of the output gradient value, which is caused to the target pixel before and after a gradient conversion can be absorbed by an output gradient value of another template data which is different from the output gradient value of the template data used in the preparing.

11. The image processing method of claim 7, wherein the output gradient value in which each pixel of the pixel block outputted when it is judged that there is template data coinciding with the pixel array of the image region in the judging, can be reproduced, can be selected by operating an operation unit.
